(19) United States
(12) Patent Application Publication
(10) Pub. No.: US 2016/0093053 A1
(43) Pub. Date: Mar. 31, 2016

(54) DETECTION METHOD AND DETECTION APPARATUS FOR DETECTING THREE-DIMENSIONAL POSITION OF OBJECT

(71) Applicant: FANUC CORPORATION, Yamanashi (JP)

(72) Inventors: Atsushi Watanabe, Yamanashi (JP); Yuuki Takahashi, Yamanashi (JP)

(21) Appl. No.: 14/865,138

(22) Filed: Sep. 25, 2015

(30) Foreign Application Priority Data
Sep. 29, 2014 (JP) 2014-199428

(51) Int. Cl. G06T 7/00; B25J 15/00; B25J 19/02; H04N 13/02

(52) U.S. Cl. CPC G06T 7/0042; H04N 13/0207; B25J 15/0019; B25J 19/021; G06T 2207/10021; G06T 2207/30244; Y10S 901/44

(57) ABSTRACT

A detection apparatus for detecting a three-dimensional position of an object includes: an image storage unit that stores sequentially two images imaged when a robot is moving; a position/orientation information storage unit that stores position/orientation information of the robot when each image is imaged; a position information storage unit that detects an object from each image and stores position information of the object; a line-of-sight information calculating unit that calculates line-of-sight information of the object in a robot coordinate system using the position/orientation information of the robot which is associated with each image and the position information of the object; and a three-dimensional position detecting unit that detects a three-dimensional position of the object based on an intersection point of the line-of-sight information.

### BACKGROUND OF THE INVENTION

1. Technical Field

The present invention relates to a detection method and a detection apparatus for detecting a three-dimensional position of an object in a system including a robot, and an imaging unit supported adjacent to a distal end of the robot.

2. Description of Related Art

In order to accurately perform an operation such as conveying or processing a workpiece using a robot, it is necessary to accurately recognize the position where the workpiece is placed. Thus, in recent years, it has been common to visually recognize the position of the workpiece, in particular, the three-dimensional position of the workpiece using a camera or the like.

In Japanese Registered Patent No. 3859371, Japanese Laid-open Patent Publication No. 2012-192473, and Japanese Laid-open Patent Publication No. 2004-90183, it is disclosed to determine a three-dimensional position of a workpiece or the like with a plurality of cameras. Further, in Japanese Laid-open Patent Publications Nos. 2014-34075 and 2009-241247, it is disclosed to determine a three-dimensional position of a workpiece using a camera including a plurality of lenses.

However, in the above conventional techniques, there is a problem that because a plurality of cameras or a plurality of lenses are used, the structure becomes complicated and the cost is increased accordingly.

Further, in a stereo camera, it is most expensive to associate a stereo-pair of images with each other. When the quality of the association of the stereo-pair of images is low, the reliability of the stereo camera is also decreased.

The present invention has been made in view of the above circumstances, and it is an object of the invention to provide a detection method for detecting a three-dimensional position of an object, wherein the reliability is enhanced while the cost is reduced, without a plurality of cameras or a plurality of lenses being used, and a detection apparatus for carrying out such a method.

### SUMMARY OF THE INVENTION

In order to achieve the above object, according to a first embodiment of the present invention, a detection method is provided for detecting a three-dimensional position of an object in a system including a robot, and an imaging unit supported adjacent to a distal end of the robot, the detection method including the steps of: imaging a first image and a second image by the imaging unit when the robot is moving; storing first position/orientation information of the robot when the first image is imaged; storing second position/orientation information of the robot when the second image is imaged; detecting the object from the first image and storing first position information of the object in an imaging unit coordinate system; detecting the object from the second image and storing second position information of the robot in the imaging unit coordinate system; calculating first line-of-sight information of the object in a robot coordinate system using the first position/orientation information of the robot and the first position information of the object, and calculating second line-of-sight information of the object in the robot coordinate system using the second position/orientation information of the robot and the second position information of the object; and detecting a three-dimensional position of the object based on an intersection point of the first line-of-sight information and the second line-of-sight information.

According to a second embodiment, the detection method of the first embodiment further includes the steps of: detecting one or more feature points in the second image including one or more feature points detected in the first image; calculating each distance between the one or more feature points in the first image and the one or more feature points in the second image; and determining the feature point, for which the distance is shortest, to be the object.

According to a third embodiment, in the detection method of the first or second embodiment, a spotlight is projected onto the object.

According to a fourth embodiment, the detection method of the first or second embodiment further includes the steps of: detecting in the second image at least three feature points located in the first image; calculating the first line-of-sight information and the second line-of-sight information, with each of the at least three feature points being the object; and detecting a three-dimensional position of each of the at least three feature points based on each intersection point of the calculated first line-of-sight information and second line-of-sight information, thereby detecting a three-dimensional position/orientation of a workpiece including the at least three feature points.

According to a fifth embodiment, a detection apparatus is provided for detecting a three-dimensional position of an object in a system including a robot, and an imaging unit supported adjacent to a distal end of the robot, the detection apparatus including: an image storage unit that stores a first image and a second image imaged by the imaging unit when the robot is moving; a position/orientation information storage unit that stores first position/orientation information of the robot when the first image is imaged and second position/orientation information of the robot when the second image is imaged; a position information storage unit that detects an object from the first image and stores first position information of the object in an imaging unit coordinate system, and detects the object from the second image and stores second position information of the object in the imaging unit coordinate system; a line-of-sight information calculating unit that calculates first line-of-sight information of the object in a robot coordinate system using the first position/orientation information of the robot and the first position information of the object, and calculates second line-of-sight information of the object in the robot coordinate system using the second position/orientation information of the robot and the second position information of the object; and a three-dimensional position detecting unit that detects a three-dimensional position of the object based on an intersection point of the first line-of-sight information and the second line-of-sight information.

According to a sixth embodiment, the detection apparatus of the fifth embodiment further includes: a feature point detecting unit that detects in the second image one or more feature points located in the first image; a distance calculating unit that calculates each distance between the one or more feature points in the first image and the one or more feature points in the second image; and an object determining unit that determines the feature point, for which the distance is shortest, to be the object.

According to a seventh embodiment, the detection apparatus of the fifth or sixth embodiment further includes a projector that projects a spotlight onto the object.

According to an eighth embodiment, the detection apparatus of the fifth or sixth embodiment further includes a feature point detecting unit that detects in the second image at least three feature points located in the first image, wherein the line-of-sight information calculating unit calculates the first line-of-sight information and the second line-of-sight information, with each of the at least three feature points being the object, and wherein the three-dimensional position detecting unit detects a three-dimensional point of each of the at least three feature points based on each intersection point of the calculated first line-of-sight information and second line-of-sight information, thereby detecting a three-dimensional position/orientation of a workpiece including the at least three feature points.

These objects, features and advantages, as well as other objects, features and advantages, of the present invention will become more apparent from a detailed description of exemplary embodiments of the present invention illustrated in the accompanying drawings.

### BRIEF DESCRIPTION OF THE DRAWINGS

FIG. 1 is a schematic view of a system including a detection apparatus based on the present invention;

FIG. 2 is a flow chart illustrating the operation of the detection apparatus illustrated in FIG. 1;

FIG. 3 is a view illustrating a robot and images associated with the movement of the robot;

FIG. 4A is a first view illustrating the robot and the associated image;

FIG. 4B is a second view illustrating the robot and the associated image;

FIG. 4C is a third view illustrating the robot and the associated image; and

FIG. 4D is a fourth view illustrating the robot and the associated image.

### DETAILED DESCRIPTION

Embodiments of the present invention will now be described with reference to the accompanying drawings. Throughout the drawings, like reference numerals are assigned to like members. The scale of the drawings is appropriately altered in order to facilitate understanding.

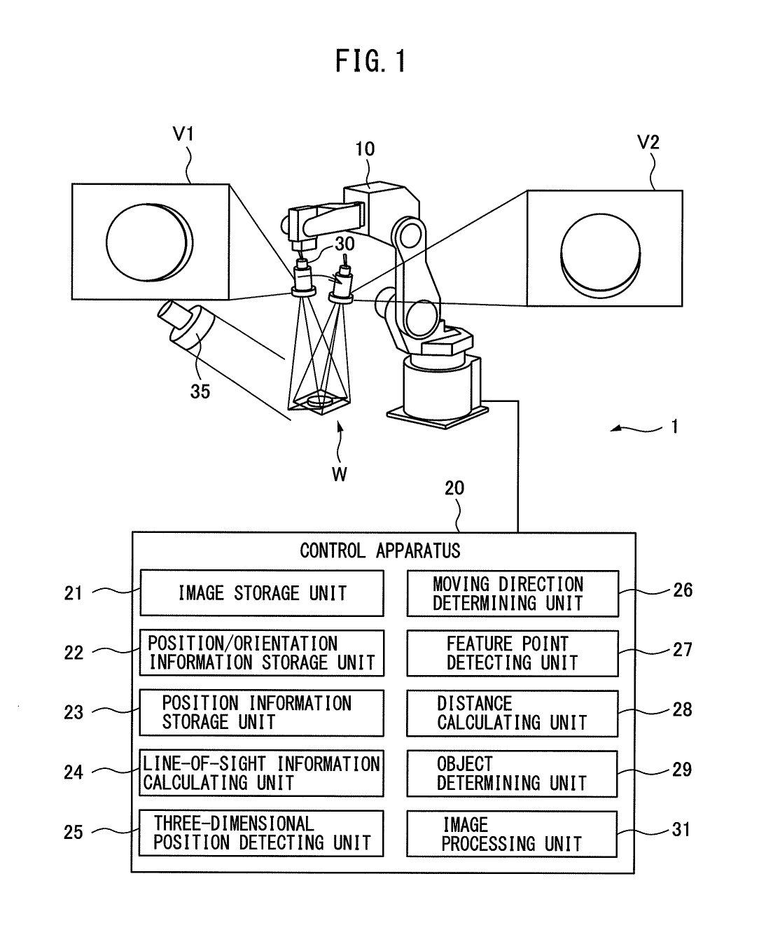

FIG. 1 is a schematic view of a system including a detection apparatus based on the present invention. As illustrated in FIG. 1, the system 1 includes a robot 10, and a control apparatus 20 that controls the robot 10. While the robot 10 illustrated in FIG. 1 is a vertically articulated robot, any other type of robot may be employed. Further, a camera 30 is supported at a distal end of the robot 10. A position/orientation of the camera 30 is determined depending on the robot 10. Any other type of imaging unit may be used instead of the camera 30.

In addition, in FIG. 1, a projector 35 is illustrated which is configured to project a spotlight onto an object W. The camera 30 can acquire a clear image using the projector 35. Thus, an image processing unit 31, which will be described hereinafter, can satisfactorily perform image processing of an imaged image. It may be configured such that the position/orientation of the projector 35 is controlled by the control apparatus 20. Meanwhile, the projector 35 may be mounted on the robot 10.

The control apparatus 20, which may be a digital computer, controls the robot 10, while at the same time serving as a detection apparatus that detects a three-dimensional position of the object W. As illustrated in FIG. 1, the control apparatus 20 includes an image storage unit 21 that stores a first image and a second image which are imaged by the camera 30 when the robot 10 is moving.

In addition, the control apparatus 20 includes a position/orientation information storage unit 22 that stores first position/orientation information of the robot 10 when the first image is imaged and second position/orientation information of the robot 10 when the second image is imaged, and a position information storage unit 23 that detects the object W from the first image and stores first position information of the object W in an imaging unit coordinate system, and detects the object W from the second image and stores second position information of the object W in the imaging unit coordinate system. Further, the control apparatus 20 includes an image processing unit 31 that processes the first image and the second image and detects an object and/or a feature point.

Furthermore, the control apparatus 20 includes a line-of-sight information calculating unit 24 that calculates first line-of-sight information of the object W in a robot coordinate system using first position/orientation information of the robot 10 and first position information of the object W and calculates second line-of-sight information of the object W in the robot coordinate system using second position/orientation of the robot 10 and second position information of the object W, and a three-dimensional position detecting unit 25 that detects a three-dimensional position of the object W based on an intersection point of the first line-of-sight information and the second line-of-sight information

The line-of-sight information unit 24 may calculate the first line-of-sight information and the second line-of-sight information respectively, with each of at least three feature points being the object. Further, the three-dimensional position detecting unit 25 may detect a three-dimensional position of each of the at least three feature points based on the intersection point of the calculated first line-of-sight information and second line-of-sight information, thereby calculating a three-dimensional position/orientation of a workpiece including the at least three feature points.

Further, the control apparatus 20 includes a moving direction determining unit 26 that determines the moving direction in which the camera 30 moves via movement of the robot 10, a feature point detecting unit 27 that detects in the second image one or more feature points located in the first image, a distance calculating unit 28 that calculates each distance between one or more feature points in the first image and one or more feature points in the second image, and an object determining unit 29 that determines a feature point, for which the above distance is shortest, to be the object.

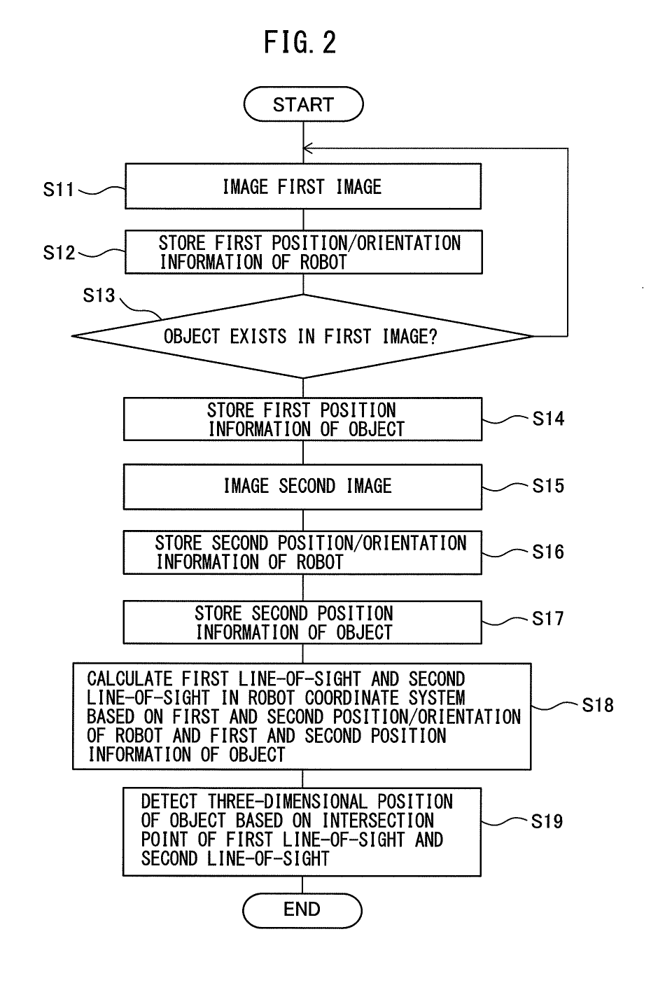

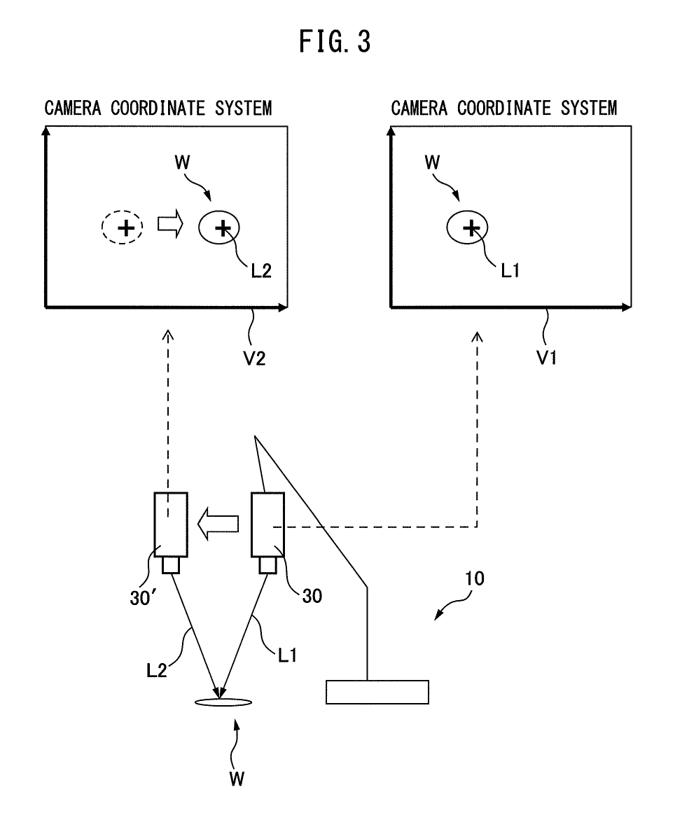

FIG. 2 is a flow chart illustrating the operation of the detection apparatus depicted in FIG. 1, and FIG. 3 is a view illustrating the robot and images associated with the movement of the robot. Referring to FIGS. 2 and 3, description will now be made of the operation of the detection apparatus based on the present invention. The robot 10 is moving in accordance with a predetermined program, and the camera 30 images the object W periodically and continuously. The object W may be the center of an opening of a workpiece or a corner portion of the workpiece, for example.

At step S11 in FIG. 2, the camera 30 images a first image V1 of the object W when the robot 10 is moving. At the right hand side of FIG. 3, the first image V1 is depicted. The imaged first image V1 is stored in the image storage unit 21. Subsequently, at step S12, first position/orientation information PR1 of the robot 10 when the first image V1 is imaged is stored in the position/orientation information storage unit 22.

Subsequently, at step S13, a determination is made as to whether the object W exists in the first image V1. In FIG. 3, the object W is depicted left to the first image V1 in the imaging unit coordinate system. In such an instance, the procedure proceeds to step S14, and first position information PW1 of the object W in the first image V1 is stored in the position information storage unit 23. Meanwhile, when the object W does not exist in the first image V1, the procedure returns to step S11.

Subsequently, at step S15, the camera 30 images a second image V2 of the object W. At the left hand side of FIG. 3, the second image V2 is depicted. The second image V2 is different from the first image V1 since the robot 10 continues moving even after the first image V1 has been imaged. The imaged second image V2 is stored in the image storage unit 21. Subsequently, at step S16, second position/orientation information PR2 of the robot 10 when the second image V2 is imaged is stored in the position/orientation information storage unit 22. As mentioned above, since the robot 10 is moving, the second position/orientation information PR2 is different from the first position/orientation information PR1.

In FIG. 3, the object W is depicted right to the second image V2 in the imaging unit coordinate system. The second position information PW2 of the object W in the second image V2 is stored in the position information storage unit 23 (step S17). As can be seen from FIG. 3, the position of the object W in the second image V2 is moved to the right with respect to the position of the object W in the first image V1. In other words, in this instance, the object W is in the field of sight of the camera 30 even when the camera 30 is moving.

Subsequently, at step S18, the line-of-sight information calculating unit 24 calculates first line-of-sight information L1 based on the first position/orientation information PR1 of the robot 10 and the first position information PW1 of the object W. Likewise, the line-of-sight information calculating unit 24 calculates second line-of-sight information L2 based on the second position/orientation information PR2 of the robot 10 and the second position information PW2 of the object W. As can be seen from FIG. 3, the first and the second line-of-sight information L1 and L2 represent lines of sight extending from the camera 30 to the object W respectively. The first and the second line-of-sight information L1 and L2 are represented by cross marks in the first image V1 and second image V2 of FIG. 3, respectively.

Subsequently, at step S19, the three-dimensional position detecting unit 25 detects a three-dimensional position of the object W based on an intersection point or approximate intersection point of the first and the second line-of-sight information L1 and L2. In this manner, according to the present invention, the two images V1 and V2 imaged while causing the robot 10 to be moved are used so that a three-dimensional position of the object W can be detected without using a plurality of cameras or a plurality of lenses as in the conventional technique. Thus, according to the present invention, it is possible to minimize the cost while simplifying the entire configuration of the system 1.

Further, in the present invention, the first image V1 and the second image V2 are associated with each other by a common object W such as the center of an opening or a corner portion, for example. Thus, the first image V1 and the second image V2 can positively be associated as a stereo pair based on the common object W. It may be configured such that such association is performed by the image storage unit 21.

Further, in the present invention, since the association is performed based on the object W, the association of the images can be performed continuously and sequentially even when the robot 10 moves at a high speed. In other words, it is not necessary to perform association of the images after the moving manipulation of the robot 10. Further, since the association of a stereo pair can be performed easily and positively, the reliability can be enhanced as compared with the conventional technique.

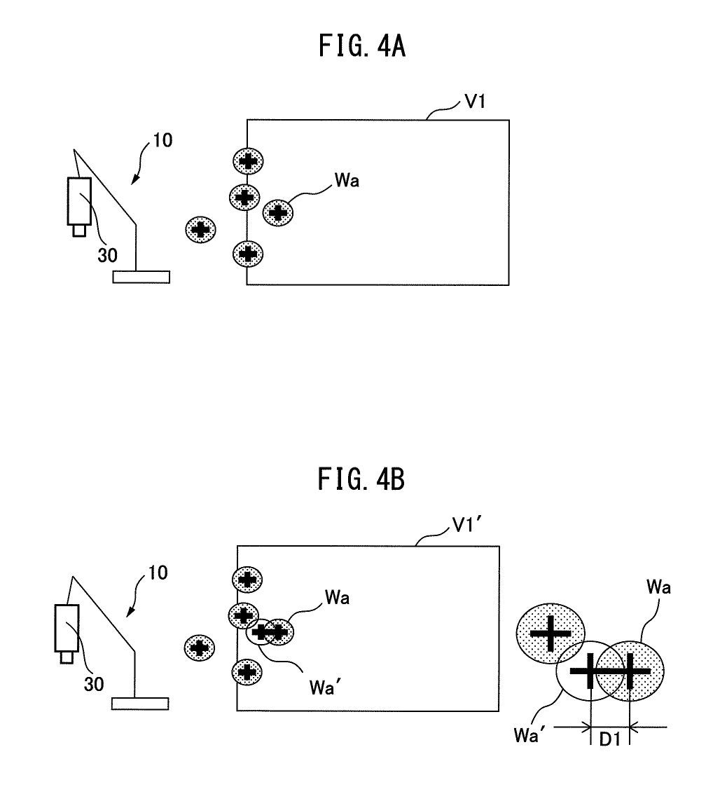

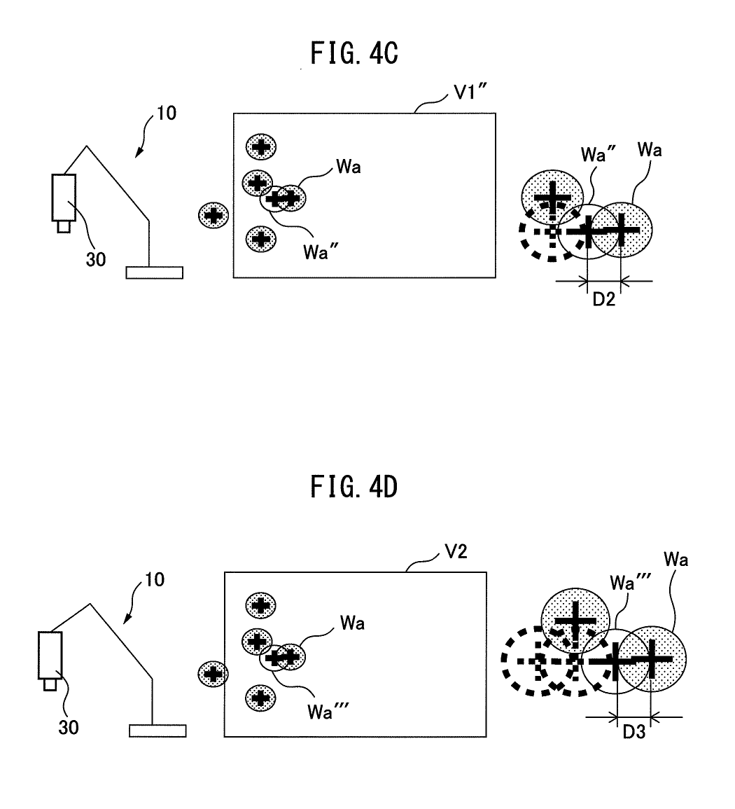

FIGS. 4A through 4D are views illustrating the robot and the associated images. In these figures, there are illustrated the robot 10, which is moving continuously, and images which are imaged in succession at the position/orientation of the robot 10 in each of FIGS. 4A through 4D. Further, at the right hand side of each figure, the imaged images are illustrated partially and on an enlarged scale.

Let it be assumed that the image imaged by the camera 30 of the robot 10 in the position/orientation illustrated in FIG. 4A is the above-mentioned first image V1, and that the image imaged by the camera 30 of the robot 10 in the position/orientation illustrated in FIG. 4B is the above-mentioned second image V2. Further, in FIGS. 4B and 4C, the states are sequentially illustrated that occur while the robot 10 is moving from the state of FIG. 4A to the state of FIG. 4D. Let it also be assumed that the image depicted in FIG. 4B is an image V1′ and that the image depicted in FIG. 4C is an image V″.

In FIGS. 4A through 4D, a plurality of feature points W are located at predetermined positions. Each of the imaged images V1, V1′, V1″, and V2 includes some of the plurality of feature points W.

Let it be assumed that one of some feature points W included in the first image V1 of FIG. 4A is an object Wa. As illustrated in FIGS. 4A through 4D, when the robot 10 causes the camera 30 to be moved to the left, the imaging position of the image is also moved to the left accordingly. Thus, the object Wa illustrated in FIG. 4B is spaced apart from the position Wa′ corresponding to the object Wa in FIG. 4A. Likewise, the object Wa illustrated in FIG. 4C is spaced apart from the position Wa″ corresponding to the object Wa in FIG. 4B. Likewise, the object Wa illustrated in FIG. 4D is spaced apart from the position Wa″′ corresponding to the object Wa in FIG. 4C.

In this manner, when one or more images V1′, V1″ are imaged between the first image V1 and the second image V2, in the two consecutive images, the distance between the object position Wa″ in the image V1′ and each feature point in the image V1″ is calculated, and the shortest of the distances is determined to be the object Wa. For example, the distance D1 depicted in FIG. 4B, the distance D2 depicted in FIG. 4C, and the distance D3 depicted in FIG. 4D are the shortest distances that determine the object Wa. This calculation processing may be performed by the distance calculating unit 28.

Since the single object Wa is tracked between the first image V1 and the second image V2 using other consecutive images V1′, V1″, . . . , the association between the plurality of images can be performed easily and positively.

The object determining unit 29 may determine the feature point W3, for which the distance to the position W0 is shortest, to be the object. In such an instance, even when the robot 10 moves at a high speed, the three-dimensional position of the object can be determined while performing the image association with ease.

Referring to FIGS. 4A and 4B, it has been described that a calculation is made of the distance between the position WO and each of the feature points W1-W3 in the second image V2. As described above, the position W0 is the position associated with the feature point W1 at the previous imaging time.

In this regard, it may be configured such that the position W0′ associated with the feature point W2 at the previous imaging time is determined and the distance calculating unit 28 calculates the distance between the position W0′ and each of the feature points W1-W3 in the second image V2. This also applies to the other feature point W3, etc. In other words, the distance calculating unit 28 may calculate each of the distances between the plurality of feature points in the first image V1 at the previous imaging time and the plurality of feature points in the second image V2.

The object determining unit 29 determines the feature point, which has the shortest distance or the feature point, which has the distance shortest of these distances, to be the object. It will be appreciated that a more appropriate object can be determined by taking into account of the distances for all the feature points in the image as described above.

Among workpieces having a plurality of feature points there is a workpiece of which three-dimensional position/orientation is determined using the three-dimensional position of at least three feature points. When determining the three-dimensional position/orientation of such workpiece, initially, the feature point detecting unit 27 detects in the second image V2 at least three feature points located in the first image V1.

The line-of-sight information calculating unit 24 calculates the first line-of-sight information and the second line-of-sight information, with each of the at least three feature points being the object. Further, the three-dimensional potion detecting unit 25 detects the three-dimensional position of each of the at least three feature points based on the intersection point of the calculated first line-of-sight information and second line-of-sight information. In this manner, the three-dimensional position detecting unit 25 can detect the three-dimensional position/orientation of the workpiece.

### ADVANTAGE OF THE INVENTION

In the first and fifth embodiments, since two imaged images are used while the robot is being moved, using a plurality of imaging units or a plurality of lenses is eliminated. Thus, it is possible to save cost while simplifying the entire configuration of the system.

Further, the first image and the second image are associated with each other by a common object such as an aperture or corner portion, for example. Consequently, the first image and the second image are positively associated with each other as a stereo pair. Further, since the association is performed based on the object, it is possible to perform the association of the images continuously and sequentially even when the robot moves at a high speed. Thus, there is no need to perform the association of the images after the moving manipulation of the robot. Further, the association of a stereo-pair can be performed easily and positively, so that the reliability can be enhanced as compared with the conventional technique.

In the second and sixth embodiments, even when the robot moves at a high speed, the three-dimensional position of the object can be determined while performing the association of the images with ease since the feature point having the shortest distance is used as the object.

In the third and seventh embodiments, a clear image can be obtained so that image processing can be performed satisfactorily.

In the fourth and eighth embodiments, the three-dimensional position/orientation of the workpiece can be detected through the three-dimensional position of three feature points which the workpiece has.

While the present invention has been described with respect to exemplary embodiments thereof, it would be understood by those skilled in the art that the above-described changes as well as various other changes, omissions, and additions are possible without departing from the scope of the present invention.

What is claimed is:

1. A detection method for detecting a three-dimensional position of an object in a system including a robot, and an imaging unit supported adjacent to a distal end of the robot, the detection method comprising the steps of:
imaging a first image and a second image by the imaging unit when the robot is moving;
storing first position/orientation information of the robot when the first image is imaged;
storing second position/orientation information of the robot when the second image is imaged;
detecting an object from the first image and storing first position information of the object in an imaging unit coordinate system;
detecting the object from the second image and storing second position information of the object in the imaging unit coordinate system;
calculating first line-of-sight information of the object in a robot coordinate system using the first position/orientation information of the robot and the first position information of the object, and calculating second line-of-sight information of the object in the robot coordinate system using the second position/orientation information of the robot and the second position information of the object; and
detecting a three-dimensional position of the object based on an intersection point of the first line-of-sight information and the second line-of-sight information.

2. The detection method according to claim 1, further comprising the steps of:
detecting one or more feature points in the second image including one or more feature points detected in the first image;
calculating each distance between the one or more feature points in the first image and the one or more feature points in the second image; and
determining the feature point, for which the distance is shortest, to be the object.

3. The detection method according to claim 1, wherein a spotlight is projected onto the object.

4. The detection method according to claim 1, further comprising the steps of:
detecting in the second image at least three feature points located in the first image;
calculating the first line-of-sight information and the second line-of-sight information respectively, with each of the at least three feature points being the object; and
detecting a three-dimensional position of each of the at least three feature points based on each intersection point of the calculated first line-of-sight information and second line-of-sight information, thereby detecting a three-dimensional position/orientation of a workpiece including the at least three feature points.

5. A detection apparatus for detecting a three-dimensional position of an object in a system including a robot, and an imaging unit supported adjacent to a distal end of the robot, the detection apparatus comprising:
an image storage unit that stores a first image and a second image imaged by the imaging unit when the robot is moving;
a position/orientation information storage unit that stores first position/orientation information of the robot when the first image is imaged and second position/orientation information of the robot when the second image is imaged;
a position information storage unit that detects an object from the first image and stores first position information of the object in an imaging unit coordinate system, and detects the object from the second image and stores second position information of the object in the imaging unit coordinate system;
a line-of-sight information calculating unit that calculates first line-of-sight information of the object in a robot coordinate system using the first position/orientation information of the robot and the first position information of the object, and calculates second line-of-sight information of the object in the robot coordinate system using the second position/orientation information of the robot and the second position information of the object; and
a three-dimensional position detecting unit that detects a three-dimensional position of the object based on an intersection point of the first line-of-sight information and the second line-of-sight information.

6. The detection apparatus according to claim 5, further comprising:
a feature point detecting unit that detects in the second image one or more feature points located in the first image;
a distance calculating unit that calculates each distance between the one or more feature points in the first image and the one or more feature points in the second image; and
an object determining unit that determines the feature point, for which the distance is shortest, to be the object.

7. The detection apparatus according to claim 5, further comprising a projector that projects a spotlight onto the object.

8. The detection apparatus according to claim 5, further comprising:
a feature point detecting unit that detects in the second image at least three feature points located in the first image,
wherein the line-of-sight information calculating unit calculates the first line-of-sight information and the second line-of-sight information respectively, with each of the at least three feature points being the object,
wherein the three-dimensional position detecting unit detects a three-dimensional position of each of the at least three feature points based on each intersection point of the calculated first line-of-sight information and second line-of-sight information, thereby detecting a three-dimensional position/orientation of a workpiece including the at least three feature points.
